(19) United States
(12) Patent Application Publication
(10) Pub. No.: US 2011/0047176 A1
(43) Pub. Date: Feb. 24, 2011

(54) CENTRALIZED DATA MAPPING FOR SITE-SPECIFIC DATA EXTRACTION

(75) Inventor: MARK A. HOFFMAN, LEE'S SUMMIT, MO (US)

Correspondence Address: SHOOK, HARDY & BACON L.L.P.;(Cerner Corporation), Intellectual Property Department, 2555 GRAND BOULEVARD, KANSAS CITY, MO, 64108-2613, US

(73) Assignee: CERNER INNOVATION, INC., Overland Park, KS (US)

(21) Appl. No.: 12/860,646

(22) Filed: Aug. 20, 2010

Related U.S. Application Data
(60) Provisional application No. 61/235,956, filed on Aug. 21, 2009.

(51) Int. Cl. G06F 17/30

(52) U.S. Cl. 707/769; 707/756; 707/E17.044; 707/E17.014

(57) ABSTRACT

Methods, systems, and computer storage media are provided for tuning extraction scripts to extract particular summary data from site systems. Categories of summary data are determined based on the summary data desired to be retrieved. Site-specific codes that correspond to the categories are received and are mapped to standard codes to provide a common nomenclature. Extraction scripts are tuned and are executed by a site system to query for summary data. The extraction scripts identify the site-specific codes associated with the summary data to be retrieved. Summary data is received in response to the execution of the extraction scripts, and the data is formatted for presentation.

### CROSS REFERENCE TO RELATED APPLICATIONS

This application claims the benefit of priority to U.S. Provisional Application Ser. No. 61/235,956 filed on Aug. 21, 2009, titled “CENTRALIZED DATA MAPPING FOR SITE-SPECIFIC DATA EXTRACTION,” the entirety of which is hereby incorporated by reference. This application is related to commonly assigned U.S. patent application entitled “DYNAMICALLY ADJUSTED RULES-BASED DECISION SUPPORT USING SITE-SPECIFIC MAPPED VALUES” (Attorney Docket No. CRNI.156781) filed concurrently herewith on the same date and incorporated in this application by reference.

### BACKGROUND

The spread of infectious disease across a population is a significant public health concern. Various governmental agencies in the United States and in other jurisdictions (such as the Centers for Disease Control and Prevention (CDC)) focus significant efforts on monitoring for suspected disease outbreaks. To accomplish this, surveillance systems have been developed to perform early signal detection by collecting, for instance, clinical data and looking for trends that suggest a disease or other health condition (collectively, an “outbreak”) is spreading within a local or regional population. Once it appears an outbreak is present, the surveillance systems or other notifications systems communicate with various health organizations and designated officials regarding the outbreak, so that steps may be taken to mitigate the health risks to the public at large or specific population sets (e.g., the elderly or infirm, patients at specific hospitals in a geographic area, etc.).

Effectively performing these types of surveillance activities, however, is a difficult task. Massive amounts of clinical data are present in healthcare information technology systems, which must be analyzed in order to perform the necessary signal detection. Such data exists in many disparate systems, which have varying levels of integrity and may not be properly maintained over time. These deficiencies can result in slow confirmation that an outbreak is actually present or present “false alarms” that desensitize organizations to real outbreaks when they happen, both of which present a real risk to public health when quick action could reduce the spread of disease.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to tuning extraction scripts that identify categories of interest by codes used by specific sites such that summary data associated with those categories is extracted upon execution of the extraction scripts. Rather than extracting all data, including data that is not of interest at the current time, the extraction scripts are customized to identify only those categories of interest. For instance, for a topic of Influenza A, categories such as whether patients have tested positive for Influenza A, whether those patients had temperatures above 101° F., and whether those patients experienced nausea or vomiting may be selected such that only the summary data associated with those categories is extracted from the site systems and returned to a central system where the data is aggregated and formatted for presentation. As each site system may have its own identifications of topics and categories, the central system gathers these site-specific codes and maps them to standards codes utilized by the central system so that when data is received from the site systems, the central systems is able to consult the mapping to determine the category with which the data is associated.

Accordingly, in one aspect, the present invention is directed to one or more computer storage media storing computer-useable instructions that, when used by one or more computing devices, cause the one or more computing devices to perform a method. The method includes determining one or more categories of summary data associated with the summary data that is to be retrieved and receiving site-specific codes that correspond to the one or more categories of summary data. Further, the method includes mapping the site-specific codes to a set of standard codes and receiving the summary data from a site system in response to execution of a set of one or more extraction scripts on the site system. The set of one or more extraction scripts identifies the site-specific codes that correspond to the one or more categories of the summary data. Additionally, the method includes utilizing the mapping to format the summary data for presentation.

In another aspect, the present invention is directed to one or more computer storage media storing computer-useable instructions that, when used by one or more computing devices, cause the one or more computing devices to perform a method. The method includes receiving a request for site-specific codes that correspond to one or more categories of summary data and providing the site-specific codes. The site-specific codes are provided to a central system where the site-specific codes are mapped to standard codes. The method further includes querying a central system to determine a subset of the site-specific codes that are to be identified in a set of one or more extraction scripts. When executed, the set of one or more extraction scripts extracts the summary data associated with the identified site-specific codes. Additionally, the method includes receiving the subset of the site-specific codes that are to be identified in the set of extraction scripts, and based on the received site-specific codes, tuning the set of one or more extraction scripts to identify the subset of the site-specific codes. Further, the method includes executing the set of one or more extraction scripts to extract the summary data and communicating the extracted summary data.

In yet another aspect, the present invention is directed to a system for extracting summary data. The system includes a web service that receives requests from site systems and in response to the requests provides the site systems with one or more site-specific codes that correspond to categories of the summary data to be extracted from the site system. Upon receiving the one or more site-specific codes, the site systems tune a set of one or more extraction scripts prior to its execution so that the extraction scripts identify the one or more site-specific codes that correspond to the categories of the summary data that to be retrieved. The web service further maps each of the one or more site-specific codes to a standard code. The system further includes an aggregator that receives the summary data extracted from the site systems and that assembles and formats the summary data for presentation. Additionally, the system includes a central database that stores the summary data received from the site.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is an exemplary system architecture suitable to implement embodiments of the present invention;

FIGS. 3-4 are flow diagrams showing methods for extracting summary data, in accordance with embodiments of the present invention;

FIG. 5 is a table that illustrates a mapping of site-specific codes to standard codes, in accordance with an embodiment of the present invention;

FIG. 6A is a table that illustrates a single site utilizing multiple codes for a single category, in accordance with an embodiment of the present invention;

FIG. 6B is a table that illustrates defined values for an extraction script, in accordance with an embodiment of the present invention;

FIG. 7 is an illustration of a mapping of site-specific codes to standard codes, in accordance with an embodiment of the present invention;

FIG. 8 is a screenshot illustrating a comparison of laboratory orders indicating suspected influenza, in accordance with an embodiment of the present invention;

FIG. 9 is a screenshot illustrating percent changes in laboratory-confirmed influenza, in accordance with an embodiment of the present invention;

FIG. 10 is a screenshot illustrating a number of patient visits with influenza-like illness in the United States, in accordance with an embodiment of the present invention;

FIG. 11 is a screenshot illustrating a number of visits with influenza-like illness in a portion of the United States, in accordance with an embodiment of the present invention;

FIG. 12 is a screenshot illustrating a line graph comparison of percents of visits with influenza-like illness, in accordance with an embodiment of the present invention;

FIG. 13 is a screenshot illustrating a bar graph comparison of visits with laboratory-confirmed influenza, in accordance with an embodiment of the present invention;

FIG. 14 is a screenshot illustrating a line graph comparison of percents of emergency department visits relative to total visits, in accordance with an embodiment of the present invention;

FIGS. 15-16 are flow diagrams showing methods for communicating dynamic threshold values, in accordance with embodiments of the present invention; and

FIG. 17 is a flow diagram showing a method for requesting dynamic threshold values, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide for systems, methods, and computer storage media for centralized data mapping for site-specific data extraction. In embodiments, the present invention enables a manageable amount of targeted summary data to be extracted in a unified way from an extensive number of sites for rapid analysis related to public health concerns, while maintaining data integrity and ensuring a high level of accuracy. As discussed further herein, extraction scripts are tuned and are uniform for a large number of sites from where summary data pertaining to a certain topic (e.g., public health concern, event, biomedical research, benchmarking) is to be extracted. The extraction scripts are uniform in the sense that they provide for querying for data associated with the same topics, but the codes used to identify various categories of data may vary depending on the specific codes used by each site.

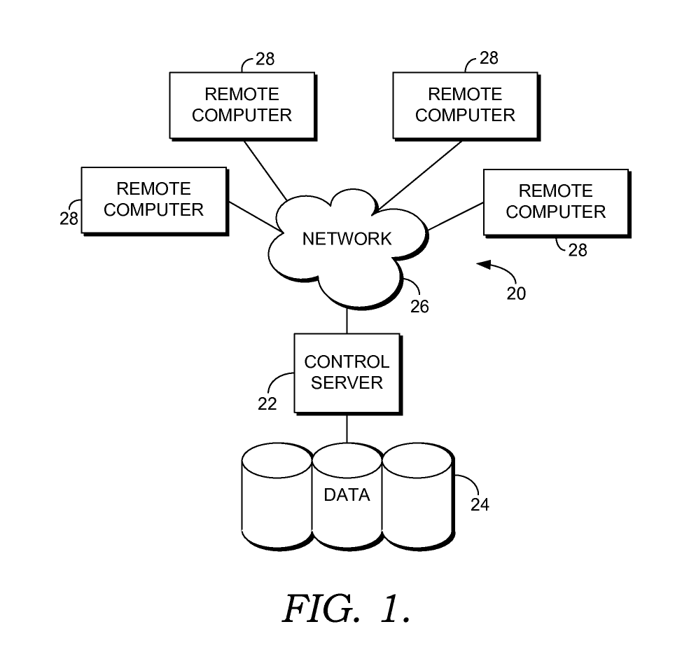

Having briefly described embodiments of the present invention, an exemplary operating environment suitable for use in implementing embodiments of the present invention is described below. Referring to the drawings in general, and initially to FIG. 1 in particular, an exemplary computing system environment, for instance, a medical information computing system, on which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a server 22. Components of the server 22 may include, without limitation, a processing unit, internal system memory, and a suitable system bus for coupling various system components, including database cluster 24, with the server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 22 typically includes, or has access to, a variety of computer-readable media, for instance, database cluster 24. Computer-readable media can be any available media that may be accessed by server 22, and includes volatile and nonvolatile media, as well as removable and non-removable media. By way of example, and not limitation, computer-readable media may include computer storage media and communication media. Computer storage media may include, without limitation, volatile and nonvolatile media, as well as removable and nonremovable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 24, provide storage of computer-readable instructions, data structures, program modules, and other data for the server 22.

The server 22 may operate in a computer network 26 using logical connections to one or more remote computers 28. Remote computers 28 may be located at a variety of locations in a medical or research environment, for example, but not limited to, clinical laboratories, hospitals and other inpatient settings, veterinary environments, ambulatory settings, medical billing and financial offices, hospital administration settings, home healthcare environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in nontraditional medical care environments so that the entire healthcare community may be capable of integration on the network. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnection are well known. Accordingly, additional details concerning the internal construction of the server 22 and the remote computers 28 are not further disclosed herein.

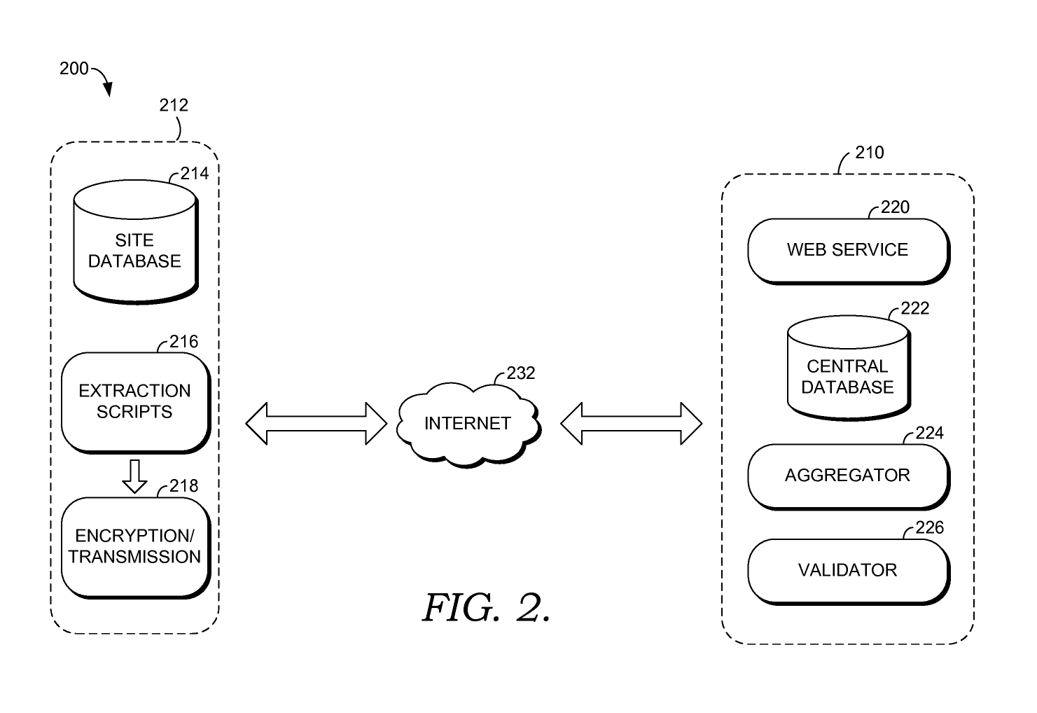

Turning to FIG. 2, an architectural framework 200 is shown for enabling site-specific data extraction via centralized data mapping. This architectural framework 200 may operate, for instance, within the context of the exemplary medical information system 20 of FIG. 1.

The system of FIG. 2 includes a central system 210 and a site system 212. The central system 210 generally instructs the site system 212 as to which particular types of summary data to extract. Generally, the central system 210, and in particular a web service 220, receives requests from the site system 212 as to which categories summary data is to be extracted. The central system 210 provides the site system 212 with site-specific codes that are specific to the site requesting the codes. The central system 210 comprises a web service 220, a central database 222, an aggregator 224, and a validator 226. Initially, extraction scripts are generated, and may be generated by the central system 210 or a third party not associated with the central system 210. These extraction scripts are installed or downloaded onto the site system 212. As used herein, extraction scripts are software that, once executed, automatically extracts various types of data from the site system 212, such as a site database. Generally, the site system 212 receives and executes extraction scripts that extract summary data from site databases. As shown, the site system 212 comprises a site database 214, extraction scripts 216, and an encryption/transmission component 218. Although shown with one site database 214, there may actually be more than one site database used to store summary data, extraction scripts, etc.

In one embodiment, the extraction scripts are uniform across a group of sites (i.e., locations/facilities where healthcare services are delivered). One or more sites may be associated with a single entity or client, such as if there are multiple locations of a single entity. As used herein, uniformity of the extraction scripts refers to the queries and categories of summary data requested, but the site-specific codes are not uniform across different sites. For instance, a first site may use a site-specific code of “123” for a patient's temperature, but a second site may use a site-specific code of “456” for the same clinical event, such as the patient's temperature. As such, a first extraction script at the first site may identify the data category of the patient's temperature as “123” so that its system knows which data to provide, but a second extraction script at the second site may identify the data category of the patient's temperature as “456” so that its system knows which data to provide.

Summary data, as used herein, refers to data associated with various patients at the site. Summary data can be divided into categories, including, for instance, general lab orders (e.g., whether a laboratory test has been ordered for a patient, such as an influenza A test), microbiology orders (e.g., influenza screen), microbiology responses (e.g., whether test results for a certain disease or sickness are positive or negative), clinical event codes (e.g., oral temperature, rectal temperature), diagnosis codes (e.g., influenza with other respiratory manifestations), etc. In some instances, summary data may not be patient-specific and may not even identify a particular patient in any way, but may include statistics, such as a number of patients who have tested positive for a certain illness, for example. As such, the summary data may provide a summary of the data stored in the site's databases. The various categories with which the summary data that is to be extracted from the site system is associated are also associated with a broader topic. Data related to these topics may be desired to compile statistics, for instance. For exemplary purposes only and not limitation, these topics may include influenza, an oil spill, childhood obesity, a salmonella outbreak, environmental factors that cause cancer, heart disease, and any other public health concern or disease outbreak. This list is not exhaustive and is provided solely for exemplary purposes only. The topic “influenza” may be any type of influenza, such as influenza A, influenza B, H1N1, etc. As an example, categories associated with the topic “influenza” may include whether a patient tested positive for influenza, whether the patient had a temperature above a certain threshold (e.g., 101° F.), and whether the patient had a cough.

In addition to these categories of information, patient demographics may also be retrieved, such as age, gender, location, etc. In embodiments, however, the data collected is not patient-specific such that it is traceable to a particular person. In these embodiments, names, addresses, or other identifying information is not retrieved such that the patients remain anonymous. Patients, however, may be associated with a certain healthcare facility, such as a doctor's office, hospital, clinic, etc. Further, the summary information, once extracted and received at the central system 210, may be viewable based on a 3-digit zip code such that the only location known about a certain patient is limited to a 3-digit zip code.

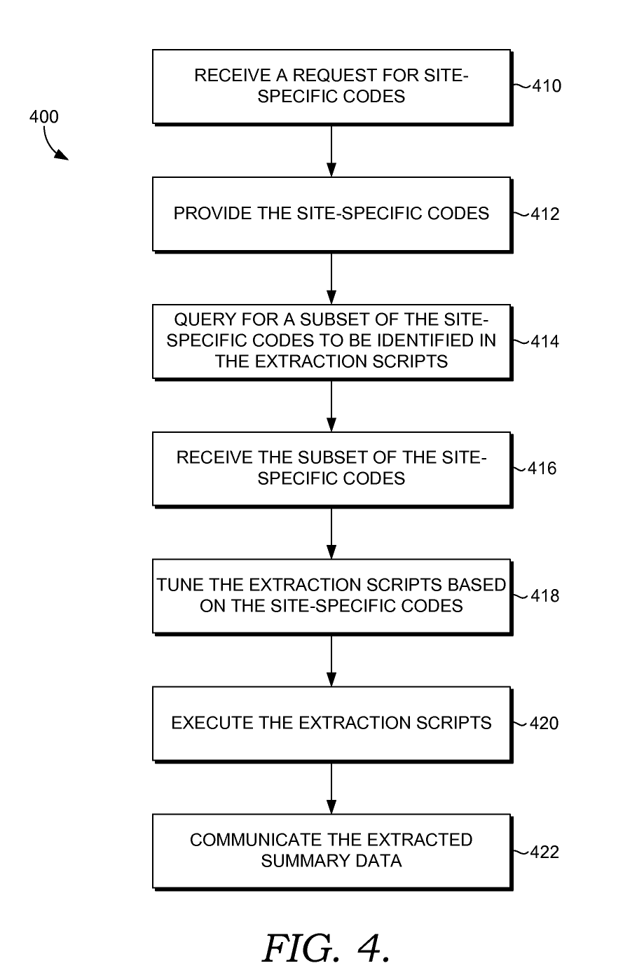

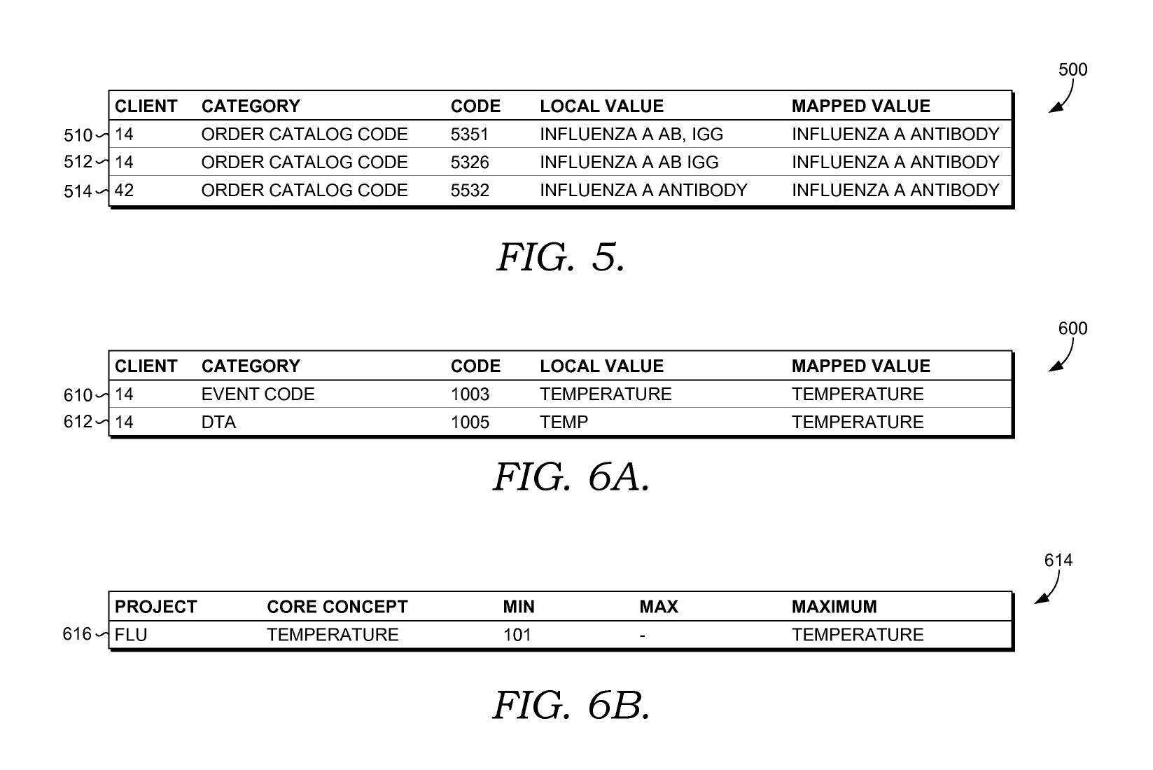

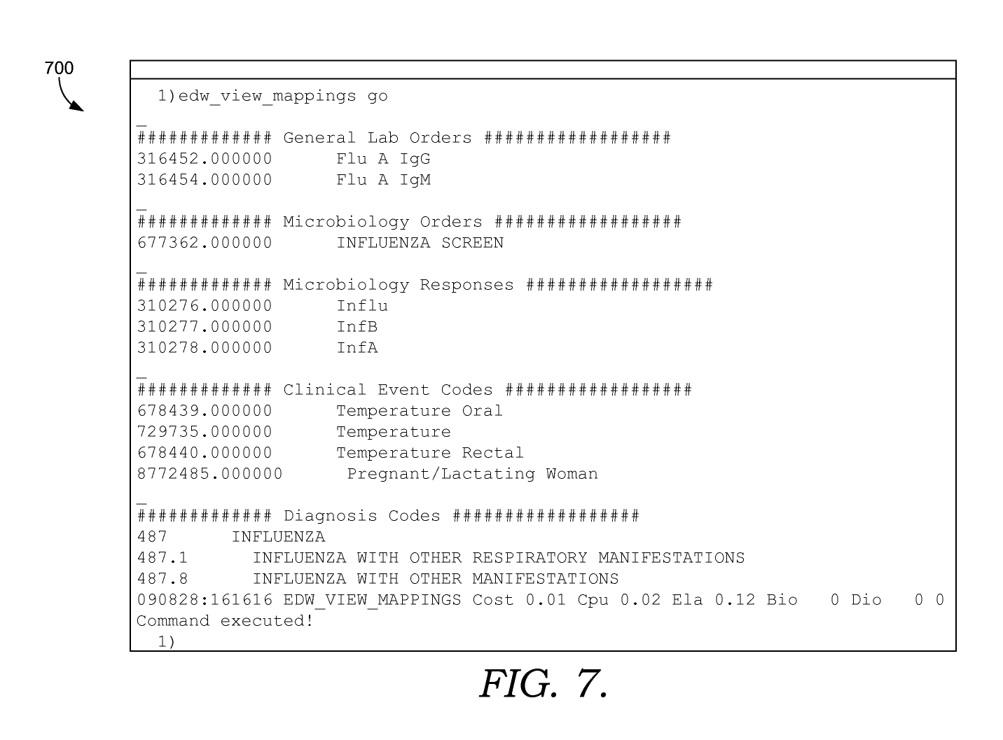

As mentioned, prior to the execution of the extraction scripts by the site system 212, site-specific codes are mapped to standard codes. Codes are used to identify specific categories of summary data to be extracted, which helps to limit the amount of information received when an extraction of data takes place. Each site may refer to the same clinical test, order, diagnosis, event, etc., by a different code. Codes, as referred to herein, may be comprised of letters, numbers, symbols, or any combination thereof. In order to standardize these different site-specific codes, standard codes are utilized by the central system 210 to define a common nomenclature. For instance, while a first site may refer to a positive influenza test result as “123,” a second site, which may or may not be associated with the same entity as the first site, may refer to the same test result as “456.” The central system 210, in order to define a common nomenclature, may always refer to the same test result as “Influenza result.” As such, a mapping is made at the central system 210 that maps each site-specific code to “Influenza result” so that when summary data is received from the site system 212, the central system 210 can consult the mapping and determine to which category the data belongs. FIGS. 5 and 6 illustrate tables of site-specific codes mapped to standard codes, and will be further discussed in greater detail herein.

The determination as to the codes that are used by a particular site system 212 to identify tests, test results, clinical events, orders, etc., may be done manually or automatically. For instance, in one embodiment, once it is determined which general topic or area is of interest (e.g., influenza, childhood obesity, heart disease, effects of an oil spill), an application automatically extracts site-specific codes from the site system 212. The central system 210 determines whether it currently has stored a standard code associated with each site-specific code. If it does, the user interaction may not be necessary. If, however, the central system 210 does not currently have a stored standard code associated with a site-specific code, a new standard code is assigned and may be reviewed by a user.

Returning now to FIG. 2, the central system 210, as mentioned, comprises a web service 220, a central database 222, an aggregator 224, and a validator 226. The web service 220 generally receives requests, which may include being periodically queried by the site system 212, to determine what type of data extraction should take place on the site system 212. In response to these requests or queries, the web service provides the site systems 212 with site-specific codes that correspond to categories of summary data to be extracted from the site system 212. As mentioned, site-specific codes corresponding to various categories of data are mapped to standard codes. Utilizing this mapping, the web service 220 directs one or more extraction scripts 216 stored on the site system 212 to perform specific data extraction activities. More particularly, the extraction scripts 216, which operate on a local system (e.g., site system 212) of each site of a group of sites, are configured to periodically, or at any selected time interval, query the web service 220 to determine what type of data extraction should take place on the site system 212. The web service 220 communicates site-specific codes to the site system 212 so that the site system 212 can tune the extraction scripts. As used herein, tuning extraction scripts refers to the process of altering or modifying the behavior of the extraction scripts by inserting a value(s) (e.g., site-specific codes) into the extraction scripts to provide an indication as to the summary data that is to be extracted by the execution of the extraction scripts. For instance, if the web service 220 provides the site system 212 with the site-specific code “123,” the site system 212 accesses the extraction scripts and inserts the value “123” into the extraction scripts so that the system knows that summary data associated with the category identified as “123” is to be extracted and returned to the central system 210.

In addition to communicating the site-specific codes to the site system 212, the web service 220 may also receive requests or queries for dynamic threshold values. Dynamic threshold values are dynamically changeable values that vary based on a number of factors. In one instance, these values vary based on the latest and most relevant research in a particular healthcare field. For example, while the current, acceptable lower threshold value of iron for a woman may be 30 ug/dL, new research in the field may indicate that the lower threshold should really be 35 ug/dL. In order to incorporate this new value into rules, extraction scripts, logic, etc. in the healthcare field, a site system 212 may query a central system 210, such as a database, to determine the most recent and relevant value. Another example may be a dynamic threshold value that represents a number of people who have been diagnosed with a certain illness, wherein if that value is met, the illness is now considered an epidemic. This threshold value may vary daily, weekly, or even more frequent than that. Even further, on an individual basis, if a patient is being treated by a clinician who is currently ordering a drug for the patient. The order for the drug may be intercepted if the patient's potassium level is greater than 5.0 mEq/L, indicating an underlying issue such that the drug should not be prescribed to the patient. A more relevant value, however, may have increased to 5.2 mEq/L. Now, the site system 212 may query the central system 210 to retrieve the most recent and relevant value of 5.2 mEq/L, which can be compared to the specific data associated with the patient, such as the patient's measured potassium levels.

Dynamic threshold values, as used herein, represent not only numerical values, but may also be portions of logic of a particular rule that are changeable. For instance, the logic “IF [A, B and C], then do action X” may be a portion of a particular rule. After initiation of that rule but prior to its execution, the site system may query the central system for any updates to the rule. If that portion of the rule has been updated to, for example, “IF [A, B, C and D], then do action X,” that portion of logic may be communicated from the central system to the site system so that the site system can update or tune the rule to reflect the updated information. In one embodiment, the site system 212 queries a central system 210 at periodic intervals of time. These intervals of time may be routine or regular, such as once a day or once a week, or may be at the discretion of the site.

Once the extraction scripts have been executed on the site system 212 and the particular summary data is extracted, the summary data is encrypted and subsequently transmitted by the encryption/transmission component 218 on the site system 212. The summary data, in one embodiment, is encrypted using 256-bit AES algorithm and is pushed through an encrypted tunnel (e.g., point-to-point encryption). The summary data is then transmitted to the central system 210, where it is stored at the central database 222. The validator 226 validates the files of summary data received from the site system 212 by comparing the number of extracted records to the number of files loaded into the central database 222 so that it can be determined if any records are missing or were not properly transmitted.

The aggregator 224 receives and assembles all of the encrypted summary data from each of the site systems 212. In one instance, once assembled, the data is transmitted to various entities that analyze the data to determine the probability of outbreak situations being present. The aggregator 224 may also note the geographic location of the site where particular data originated (e.g., via the site identifier or other means of identifying the particular local system supplying certain data), so that proper geographic significance can be applied to the data that may suggest an outbreak. Additionally, data is linked to a geographical location so that the various sites from where the data originates can access the data and compare its data to data from other sites, such as other states. The aggregator 224 further determines the information necessary for the extraction scripts 216 to function, and selectively pushes the information to the web service 220. Communication between the site system 212 and the central system 210 may be via the Internet 232 using various protocols, such as the SSL protocol, the SSH protocol, SMPT protocol, or any other protocol providing adequate data communication security and integrity. Once the summary data is aggregated and validated, it is formatted (e.g., by the aggregator 224) for presentation on a web page to which sites are allowed access, such as by way of the Internet 232.

As mentioned, the site system 212 may query the central system 210, and more particularly the web service 220, to determine additional categories of summary data to query and retrieve from the site system 212. In one embodiment, the query from a particular site system 212 to the web service 220 includes a site identifier, which may be a code or other value, that identifies the particular site of the site system 212. The web service 220 communicates back to the site system 212 one or more additional site-specific codes that may not currently be identified in the extraction scripts 216 stored on the site system 212, as well as other pertinent information. For instance, along with the additional site-specific codes, a category name associated with each site-specific code may be transmitted to the site system 212. As previously described, each site-specific code may be associated with a healthcare order (e.g., a specific medication dose and route, a diagnostic test) or other concept (e.g., a particular clinical event being noted, such as a patient having an internal body temperature above a certain value, presenting with certain symptoms or problems).

In one embodiment, the extraction scripts 216 may extract the particular summary data from any type of electronic record where summary data is stored, such as an electronic medical record (EMR) or health record (EHR), a personal health record (PHR), or any other type or record or patient data storage form. The extensible mark-up language (XML) framework or any other appropriate framework may be utilized by the web service 220 in communicating the necessary site-specific codes and other information to the site system 212. The summary data, whether stored in an EMR, EHR, etc., may be stored in a site database.

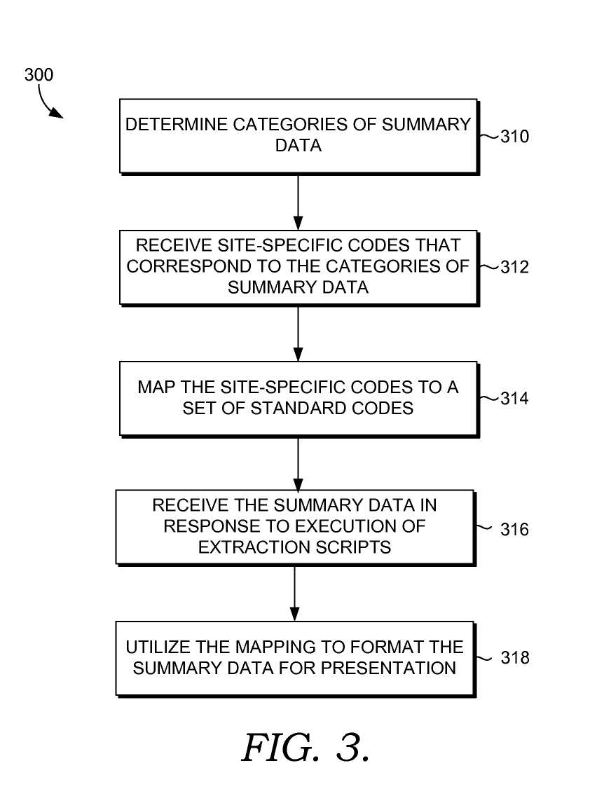

FIG. 3 is a flow diagram showing a method 300 for extracting summary data, in accordance with an embodiment of the present invention. The method of FIG. 3 is from the perspective of a central system, such as central system 210 described in relation to FIG. 2. Initially, at step 310, categories of summary data associated with summary data that is to be retrieved are determined. As previously mentioned, various categories may be associated with a particular topic. Topics, as used herein, refer to any area that would have data associated with it. Some exemplary areas include areas of public health concern, an event, disease outbreaks, biomedical research, benchmarking, etc. More particularly, these areas may include influenza, an illness due to an oil spill, childhood obesity, a salmonella outbreak, environmental factors that cause cancer, heart disease, or the like. The list of examples provided above is not exhaustive, but rather is provided for illustrative purposes only. Categories may include various sub-areas that are associated with the topic to which the categories below. For instance, categories associated with a health-related topic may include general lab orders (e.g., whether a laboratory test has been ordered for a patient, such as an influenza A test), microbiology orders (e.g., influenza screen), microbiology responses (e.g., whether test results for a certain disease or sickness are positive or negative), clinical event codes (e.g., oral temperature, rectal temperature), diagnosis codes (e.g., influenza with other respiratory manifestations), etc. For exemplary purposes only, the topic of “influenza A” may have several categories of interest from which summary data is retrieved, including whether the patient tested positive for influenza A, whether the patient's temperature is above 101° F., whether the patient had nausea or vomiting, etc. Other summary data may be associated with influenza A, but may not be needed at the current time. Extracting only the relevant data, and more particularly, extracting only the data that is desired at the current time for a particular topic saves not only storage space needed for the extracted data but is also more time and energy efficient.

At step 312, site-specific codes are received that correspond to the determined categories of summary data. Each site may utilize a different nomenclature for identifying topics and categories associated with summary data that is to be extracted. As such, a system is put in place to provide a common nomenclature. Standard codes are used to provide this common nomenclature. At step 314, the site-specific codes are mapped to standard codes so that when data is received, it can be associated with the category to which it belongs and aggregated with data of the same category received from other sites. The mapped codes may be stored in a central database at the central system. In one instance, mapping the site-specific codes to the standard codes comprises associating the site-specific codes with the standard code. The associated codes represent a similar or the same category of summary data. As mentioned, this association of codes is stored in a database.

At step 316, the summary data is received from a site system in response to the execution of a set of one or more extraction scripts on the site system. The extraction scripts are executed at a site system and are used to query for particular summary data associated with the determined categories of summary data. As such, the extraction scripts identify the site-specific codes that correspond to the categories. Along with the summary data may be a site identifier that is used to identify the site from which the data is sent. Further, the patient-specific data may be communicated to the central system in a way such that the data is associated with the category to which it belongs. In one embodiment, for a particular topic, extraction scripts are relatively uniform among different sites at which the extraction scripts are executed. One difference among the extraction scripts is the site-specific codes that are identified in the extraction scripts. The mapping is utilized at step 318 to format the summary data for presentation. In one instance, the site is provided access to the formatted summary data and may be able to compare the site's data with data from other sites, including sites in different cities, states, zip codes, etc. The data may also be accessible to public health officials and other third parties.

In one embodiment, the site-specific codes may be identified in the extraction scripts at the time they are downloaded or installed on the site system. Here, the site system may communicate a request for additional site-specific codes associated with summary data that is to be retrieved. The central system then communicates additional site-specific codes, if any, to the site system for inclusion in the extraction scripts. In an alternative embodiment, site-specific codes may not be identified in the extraction scripts initially, but when the site system is ready to execute the extraction scripts, or on a periodic basis, it may communicate a request to the central system, and specifically to the web service for the site-specific codes associated with the desired summary data. The central system communicates the site-specific codes that are to be identified in the extraction scripts to the site system so that the site system can tune the extraction scripts to identify the site-specific codes.

Referring to FIG. 4, a flow diagram of a method 400 for extracting summary data is shown, in accordance with an embodiment of the present invention. Initially at step 410, a request for site-specific codes is received. The site-specific codes correspond to one or more categories of summary data. The site-specific codes are provided at step 412. In particular, the site-specific codes are provided to a central system that maps the site-specific codes to standard codes. A central system is queried at step 414 to determine a subset of the site-specific codes that are to be identified in a set of one or more extraction scripts. When executed, the extraction scripts extract summary data associated with the identified site-specific codes. The extracted summary data may comprise only a portion of the total amount of data stored in the site database, or even a portion of a particular patient's data that is stored in the site system. As mentioned, the summary data may be extracted from any type of record or database, including, for instance, an EMR, EHR, PHR, or the like.

At step 416, the subset of site-specific codes is received so that these codes can be identified in the set of one or more extraction scripts. At step 418, based on the received site-specific codes, the extraction scripts are tuned to identify the subset of the site-specific codes. As previously mentioned, tuning extraction scripts refers to the process of altering or modifying the behavior of the extraction scripts by inserting a value(s) (e.g., site-specific codes) into the extraction scripts to provide an indication as to the summary data that is to be extracted by the execution of the extraction scripts. At step 420, the set of extraction scripts is executed to extract the particular summary data. The extracted summary data is then communicated at step 422 to, for example, the central system. The summary data may be encrypted prior to being sent to the central system.

In one embodiment, additional site-specific codes associated with additional categories of summary data are received. Here, additional summary data associated with the additional categories is desired. Once the additional site-specific codes are received, the site system tunes the extraction scripts by incorporating these codes into the set of extraction scripts such that when executed, the set of extraction scripts will extract the additional summary data associated with the additional site-specific codes. The extraction scripts are executed at the site system and are stored in a site database.

Further, in another embodiment, the extraction scripts may not identify any site-specific codes when installed or downloaded onto the site system. Instead, the site system may query the central system to determine the site-specific codes that are to be identified in the extraction scripts so that when executed, the extraction scripts extract the summary data associated with the identified site-specific codes. The site-specific codes are received, and the extraction scripts are modified to include the received site-specific codes. Alternatively, the site-specific codes may be identified in the extraction scripts, but the site system may query the central system prior to executing the extraction scripts to identify any other data that the central system desires to be extracted.

Turning now to FIG. 5, a table 500 is shown that illustrates a mapping of site-specific codes to standard codes, in accordance with an embodiment of the present invention. The table 500 of FIG. 5 illustrates a centralized mapping service that is based on values or codes (e.g., site-specific codes) from multiple sites that together create a master dictionary where site-specific codes are mapped to standard codes or values. Items 510 and 512 contain information from the same site, here identified by site identifier “14.” As shown, the site-specific codes are different, as one is “5351” and the other is “5326.” The local values, however, are nearly identical. As such, each entry, although they have different site-specific codes, is mapped to the same standard code, here shown as “Influenza A Antibody.” The third entry, item 514, is a mapping from a different site, here identified as “42.” The site-specific code is “5532” and the local value is slightly different than that used by site 14. However, because all three entries 510, 512, and 514 are directed to the same test result, the same mapped value is used. As such, the dictionary web service shown here is configured to include all site-specific codes related to a certain test result. In one embodiment, a single site may use different site-specific codes for the same test result because the single site may be comprised of multiple sites or locations. A first site associated with site B may use site-specific code “5351” for influenza A Ab, IgG results, but a second site associated with site B may use site-specific code “5326” to refer to the same test results. In one embodiment, the extraction scripts at site 14 are activated through a periodic time window (e.g., nightly). The site system pings or queries the web service and includes the site identifier with the query. Other information may include the date and time of the system's last update. In one instance, the web service returns “Order catalog code 5351: Order catalog code 5326.” In an embodiment, the extraction scripts limit the select clause to only those orders with a specified number of catalog codes (e.g., two).

FIG. 6A is a table 600 illustrating a single site utilizing multiple codes for a single category, in accordance with an embodiment of the present invention. As shown, a single site, identified as site 14, may store the same type of data, such as patients' temperatures, in different categories. Here, a first entry 610 is associated with category “Event code” and a second entry 612 is associated with category “DTA.” The central system is configured to aggregate numeric results indicating temperature, only pulling those that are 101° F. or higher, for example. Some sites use multiple data types to store temperature, as shown in FIG. 6A. FIG. 6B illustrates a table 614 having an entry 616 that defines that only temperatures of 101° F. or higher are desired. A custom extraction script for the topic “Flu” queries the web service and receives back “Event code; 1003, DTA; 1005. This extraction script only pulls records in which the value for any “temperature” field exceeds the minimum value of 101.

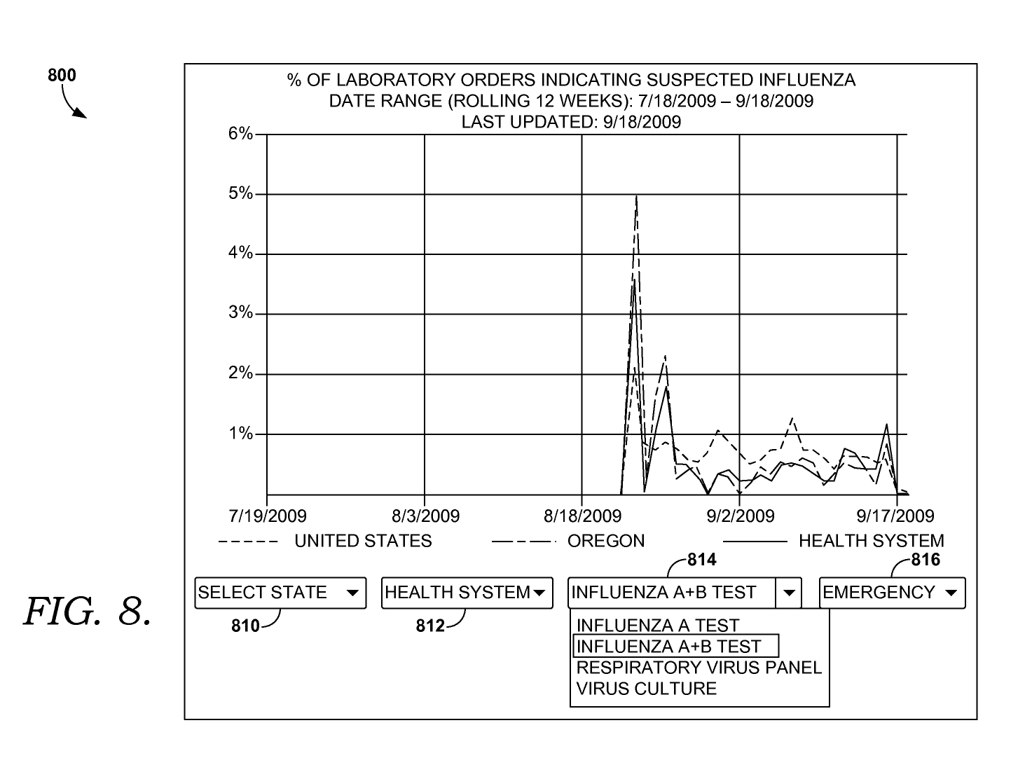

FIG. 7 is an illustration of a mapping 700 of site-specific codes to standard codes, in accordance with an embodiment of the present invention. As mentioned, site-specific codes may differ from site to site, and therefore in order for the central system to monitor and keep track of data received from different sites, standard codes are utilized. FIG. 7 illustrates various groupings of categories, such as general lab orders, microbiology orders, microbiology responses, clinical event codes, and diagnosis codes. For a particular site, for instance, a site-specific code of “316452” may be used to refer to an influenza A IgG test result. “Flu A IgG” shown here is the mapped value, or the standard code used by the central system. As shown, “316452” is associated with “Flu A IgG.” Other associations and mappings are shown in FIG. 7.

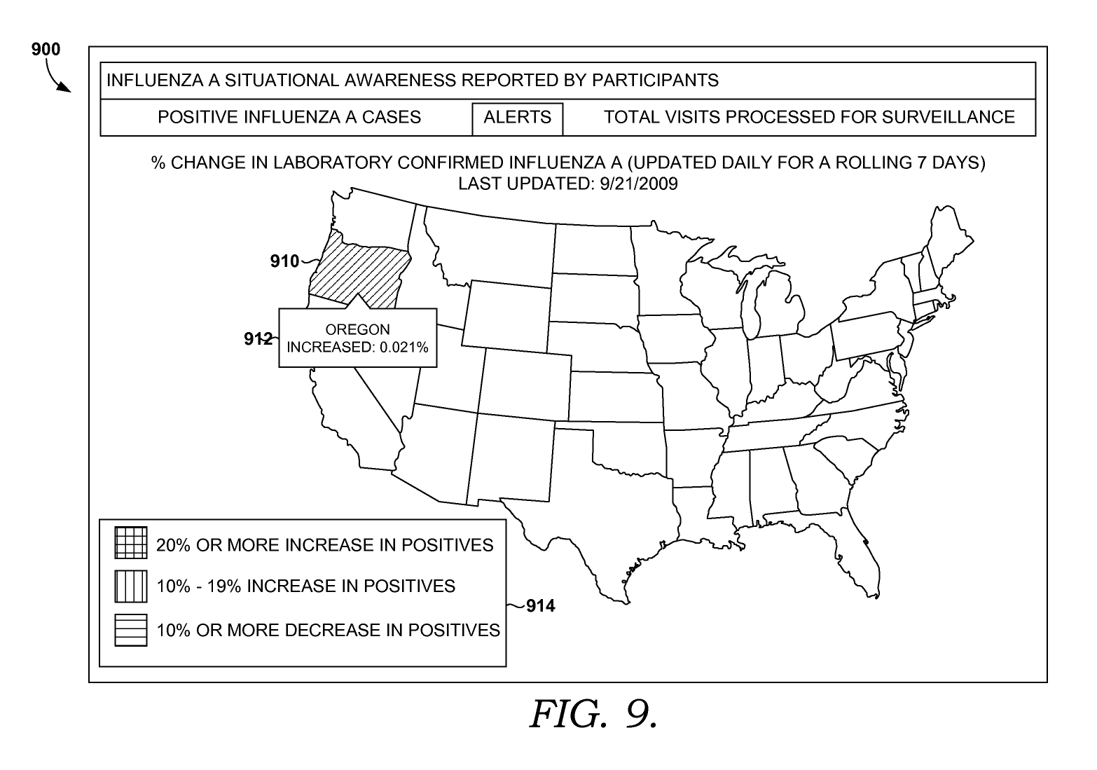

Referring to FIG. 8, a screenshot 800 is shown illustrating a comparison of laboratory orders indicating suspected influenza, in accordance with an embodiment of the present invention. FIG. 8 illustrates a line graph for demonstrating a comparison of a percentage of laboratory orders indicating suspected influenza for a certain date range, here for the previous twelve weeks. Shown here, data is not available for the entire 12-week period, but for only a portion of that time starting somewhere between Aug. 18, 2009 and Sep. 2, 2009. The line graph can be customized based on which data a user wishes to view and compare. For instance, a state may be selected at dropdown box 810. A specific health system may be selected at dropdown box 812. At dropdown box 814, the user may select a type of data or topic, such as influenza A test, influenza A+B test, respiratory virus panel, or virus culture. At dropdown box 816, a user may select a certain healthcare facility at which the laboratory orders were made. An emergency room is one example, but others may include a doctor's office or a clinic. As shown, this type of line graph is useful for a user located in a particular state, here Oregon, to compare its data to accumulated data throughout the United States.

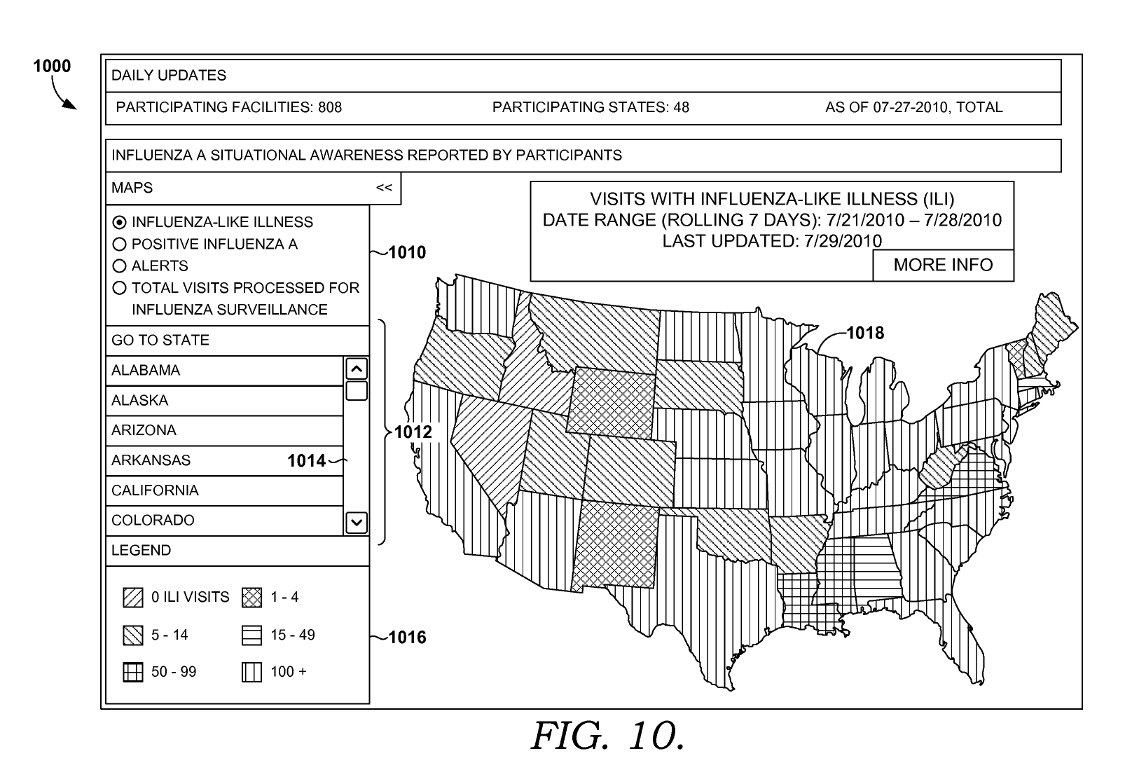

Turning to FIG. 9, a screenshot 900 illustrating percent changes in laboratory-confirmed influenza is shown, in accordance with an embodiment of the present invention. The screenshot 900 of FIG. 9 allows a user to view a percent decrease in laboratory-confirmed influenza A for various states, including the state in which the user or the user's healthcare facility is located. In one embodiment, a user hovers over a state, such as state 910, and a pop-up box 912 appears that names the state and the percent increase or decrease change in laboratory-confirmed influenza A. The states may be color coded or coded in some other way (e.g., line variations) to illustrate an increase or decrease in positive test results. In the embodiment of FIG. 9, the state of Oregon 910 is shown with diagonal stripes, which does not match any of the coding shown in the legend 914, as it is only a 0.021% increase. The legend 914 illustrates horizontal and vertical overlapping lines for a 20% or more increase in positives, vertical lines only for a 10%-19% increase, and horizontal lines only for a 10% or more decrease in positives.

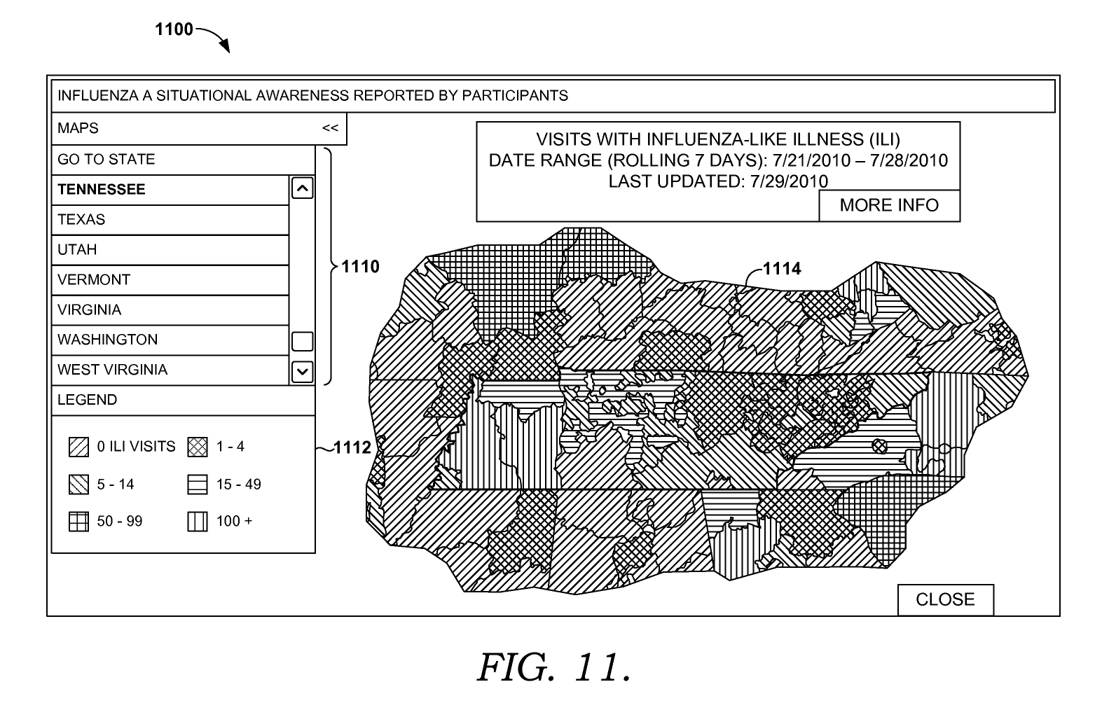

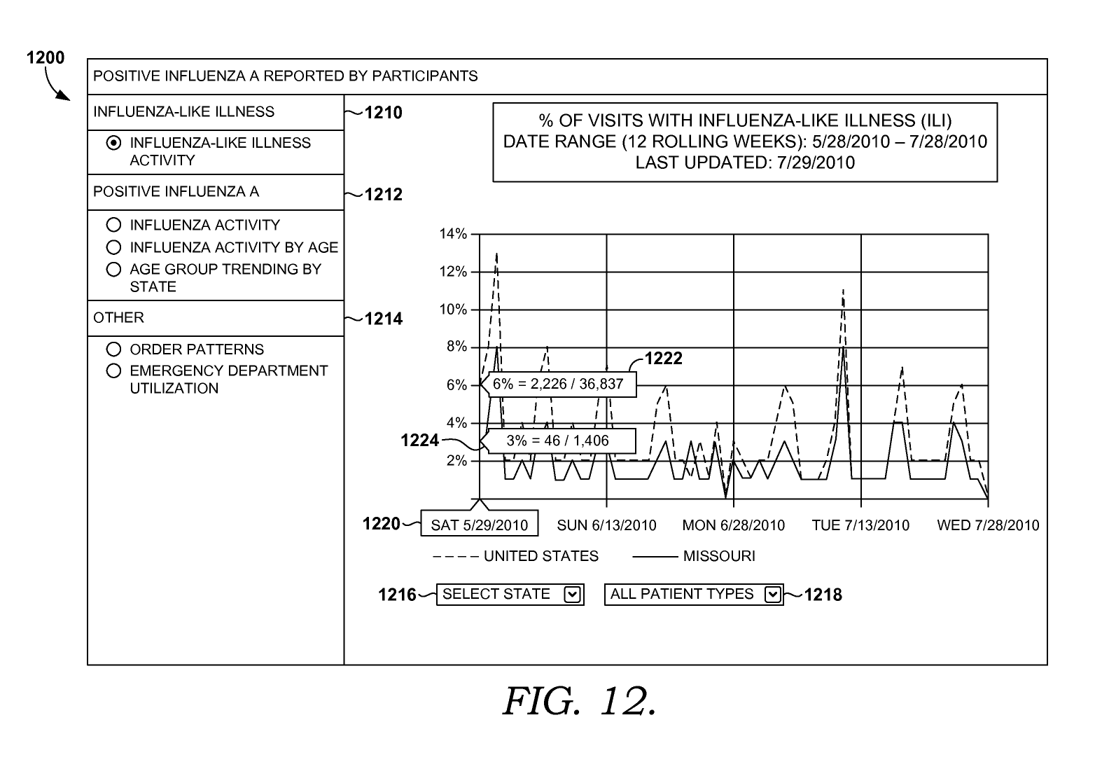

FIG. 10 is a screenshot 1000 illustrating a number of patient visits with influenza-like illness (ILI) in the United States, in accordance with an embodiment of the present invention. Included on the screenshot 1000 is a selection area 1010 that allows a user to select the type of data shown on the map of the United States 1018. For instance, a user may select to view data associated only with influenza-like illness, positive influenza A, alerts, or total visits processed for influenza surveillance. These selections are shown for illustrative purposes only and may vary. Selection area 1012 includes a scroll bar 1014 that allows a user to select which state the user would like to focus on, which is discussed further in relation to FIG. 11. Further, a legend 1016 illustrates various patterns or colors to help the user clearly comprehend the presented data, such as the number of visits with influenza-like illness in each state. Here, the data is from the last seven days, but this number may vary.

Turning to FIG. 11, a screenshot illustrating a number of visits with influenza-like illness in a portion of the United States is shown, in accordance with an embodiment of the present invention. As mentioned with regard to FIG. 10, a user may select at 1110 a particular state, such as Tennessee, and only the selected state and surrounding states or a portion thereof may be show at 1114. This allows a much more detailed analysis of the selected state. In some instances, the state and surrounding areas are broken up into three-digit zip codes when allowable. Various state and/or federal privacy requirements may only allow this type of data to be viewable when more than a certain number of people reside in that three-digit zip code area. Therefore, as shown in area 1114, the state of Tennessee is broken into 3-digit zip codes and each of these areas is marked according to the legend 1112, which represents a number of visits with influenza-like illness so that health officials and others can view the data and determine which areas of the state and surrounding states have the highest or lowest visits with influenza-like illness. Other test results, events, etc., may be represented in the manner shown in FIGS. 10 and 11. Influenza-like illness is but one example of data than can be represented in this manner.

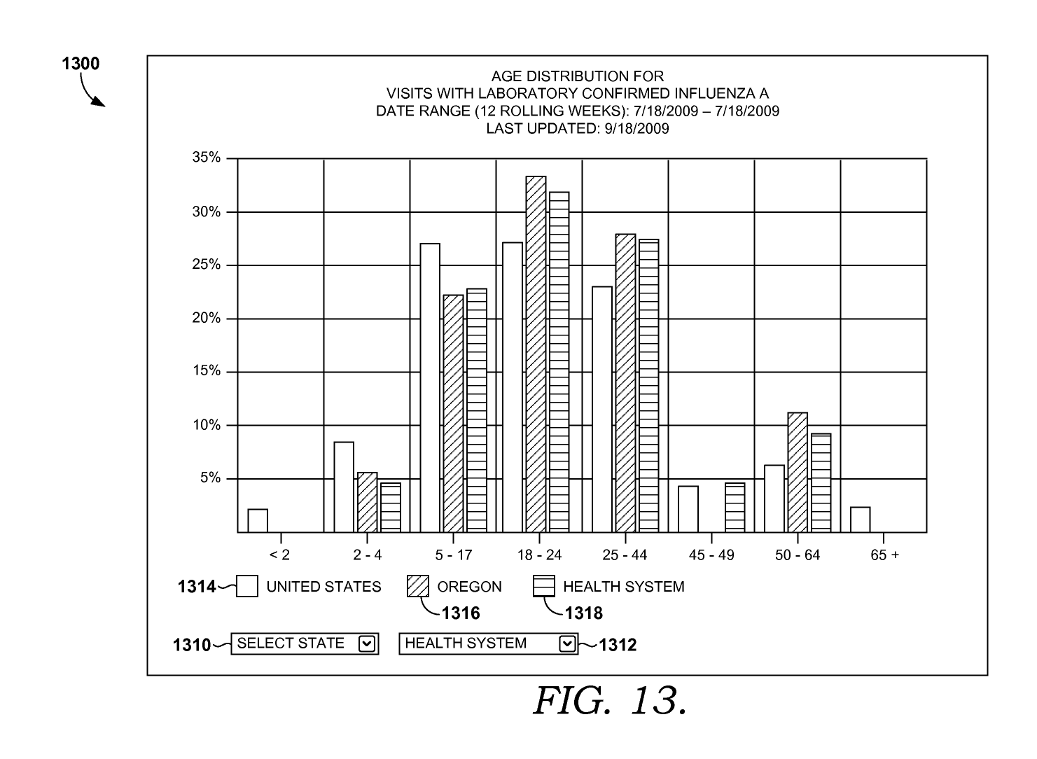

Referring now to FIG. 12, a screenshot 1200 illustrating a line graph comparison of percents of visits with influenza-like illness is shown, in accordance with an embodiment of the present invention. Initially, two selection areas 1210 and 1212 are shown, which allow a user to select the type of data depicted on the line graph and to further sort that data by age, state, etc. Selection area 1214 also allows a user to further define the data depicted on the line graph. As shown, in one embodiment, a user may hover over a certain date 1220 and statistics or data associated with that date may appear. For example, when hovering over “SAT May 29, 2010,” two sets of data are displayed, including data for the United States 1222 (in broken lines) and data for Missouri 1224 (in a solid line). Near the bottom of the screenshot 1200 are dropdown boxes. The first dropdown box 1216 allows a user to select a state whose data is compared to data from the entire United States. A second dropdown box 1218 allows a user to select a type of patients, such as all patients.

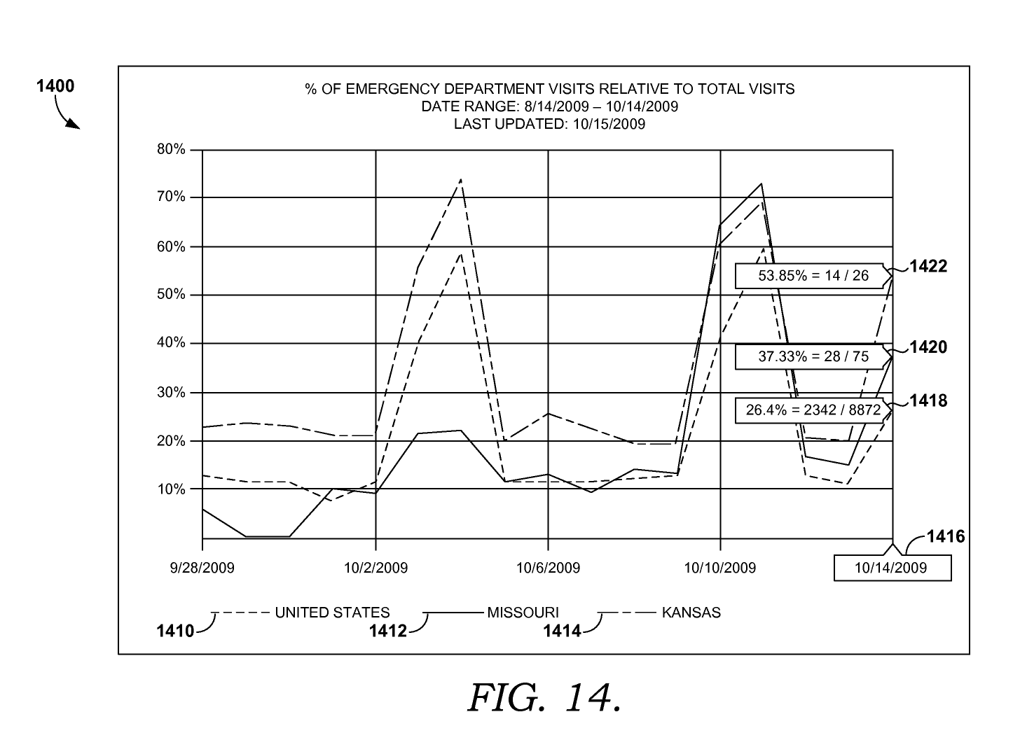

FIG. 13 is a screenshot 1300 illustrating a bar graph comparison of visits with laboratory-confirmed influenza, in accordance with an embodiment of the present invention. Here, a bar graph presents data to a user. The state from which the data is from can be selected at dropdown box 1310, and the health system or other entity from which data is from can be selected at dropdown box 1312. The bars in the bar graph may be color coded or coded by lines, as shown in FIG. 13. A legend illustrates boxes 1314, 1316, and 1318, which assist the user in understanding where the data is from. This type of graph allows for an easy comparison of data from one state compared with other health systems and the United States. This particular graph illustrates data by age group, such as less than two, two to four, etc.

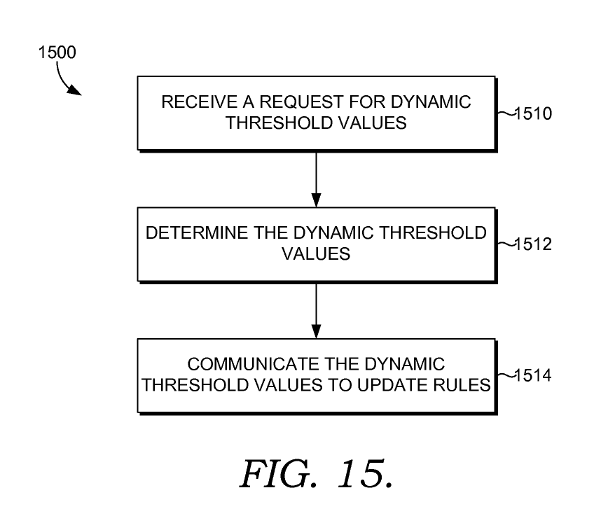

Referring to FIG. 14, a screenshot 1400 is shown illustrating a line graph comparison of percents of emergency department visits relative to total visits, in accordance with an embodiment of the present invention. The screenshot 1400 illustrates a line graph with three different sources of data. The first is from the United States 1410, the second is from the state of Missouri 1412, and the third is from the state of Kansas 1414. In one embodiment, a user may hover over a particular date, such as “Oct. 14, 2009” 1416 shown here, and data from each source may be displayed, such as data from the United States 1418, from Missouri 1420, and from Kansas 1422.

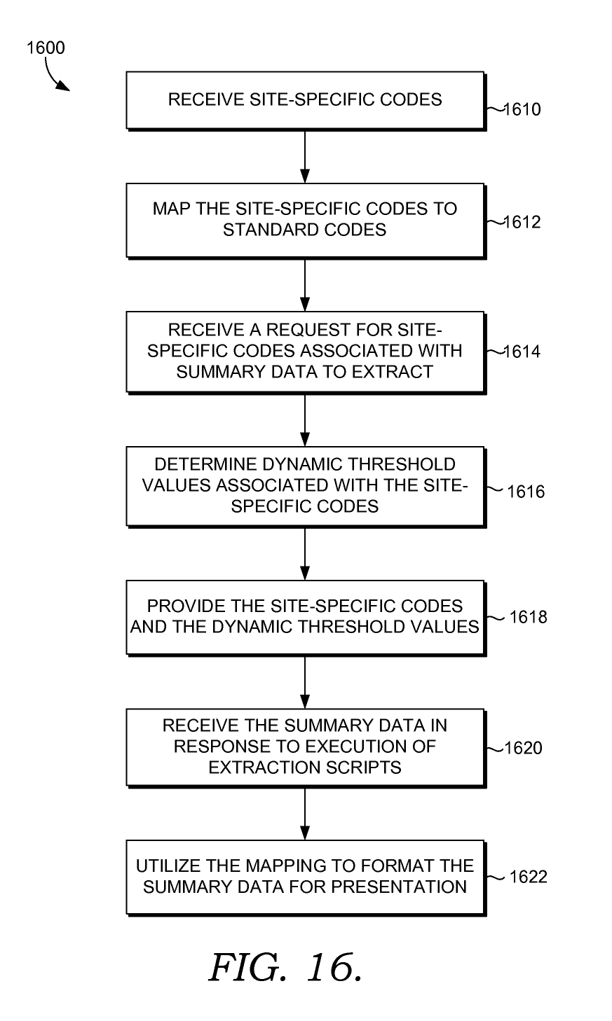

FIG. 15 is a method 1500 for communicating dynamic threshold values, in accordance with an embodiment of the present invention. As previously mentioned, a site system may query a central system or some other system to retrieve dynamic threshold values that can be used in values, logic, extraction scripts, treatment of patients, etc. Dynamic threshold values, as used herein, are dynamically changeable values that may be changed on the central system side, rather than on the site system side such that the site system requests these values from the central system. When used in the context of data extraction, the variance of dynamic threshold values may alter the amount or change the type of retrieved summary data. Initially, at step 1510, a request for dynamic threshold values is received, such as at a central system. In embodiment, the request may also include a site identifier that identifies the site that is requesting the values. More than one request may be received from a site system. These additional requests may be received from a particular site at periodic intervals of time, which may be regular intervals of time or at irregular intervals of time. These additional request may even be for the same dynamic threshold values such that the site is confident that the values it is using are the most up-to-date values available. Intervals of time may be hourly, daily, weekly, monthly, etc. Additionally, the request from the site system may be sent to the central system upon the initiation of one or more rules. For instance, before a rule executes but after the rule is initiated, the rule may trigger the site system to communicate the request for the central system for the dynamic threshold values. At step 1512, the dynamic threshold values are determined. In one instance, a database stores the dynamic threshold values and is updated each time a value changes. The changes to the dynamic threshold values may be made automatically or manually. In embodiments, a lower and an upper dynamic threshold value may be determined together, as they may pertain to the same type of value. For instance, the normal iron level for a woman may be between a lower and an upper threshold value, and as such these values are related and may be determined and sent to a site system together.

The dynamic threshold values are communicated at step 1514 and are used to update or tune one or more rules. As used herein, a rule may extraction scripts, or any other coded logic. For instance, in one embodiment, a result is used in association with patient care on an individual basis such that a clinician treats a patient based on the dynamic threshold values received. For example, a particular rule may be used to intercept a drug order for a patient when the patient's potassium levels are above a threshold amount. This threshold amount may vary based on updated research, updated healthcare knowledge at the current time, demographics of a particular patient, etc. This threshold amount may be a dynamic threshold value in that it can vary. The rules may be automatically tuned at a particular site using the received dynamic threshold values. For instance, when the values are received, one or more rules may automatically be modified to include the updated dynamic threshold values, thus eliminating a need for user intervention. In fact, the clinician and other users may not even know an updated value has been received. In another embodiment, however, the dynamic threshold values may be received and a clinician or other user may manually compare those values to the patient's individual values (e.g., patient-specific data), such as test results associated with that patient so that the clinician can determine if an action needs to be taken based on the comparison. Alternatively, an action may automatically be recommended to the clinician based on a comparison of the patient-specific data to the dynamic threshold values. In yet another embodiment, rules are used in association with healthcare data extraction such that extraction scripts used to extract summary data, as discussed herein, are tuned based on the dynamic threshold values received.

Turning to FIG. 16, a method 1600 is illustrated for communicating dynamic threshold values, in accordance with an embodiment of the present invention. Initially, at step 1610, site-specific codes are received. Each site-specific code corresponds to a category of summary data. At step 1612, the site-specific codes are mapped to standard codes such that this association is stored in a database, such as a database associated with the central system. Mapping the site-specific codes to standard codes comprises associating each of the site-specific codes to a standard code, wherein each represents the same or a similar category of summary data, and storing the association of the site-specific codes and the standard codes in a database, as previously mentioned. A request is received at step 1614 for site-specific codes associated with summary data that is to be extracted from a particular site system. In one embodiment, a separate request is received for dynamic threshold values, but in other embodiments, the request may be implied by the request for site-specific codes, or the request for dynamic threshold values may be incorporated into the request for site-specific codes. At step 1616, dynamic threshold values associated with the site-specific codes are determined. Dynamic threshold values may be determined for one or more of the site-specific codes associated with the summary data to be extracted. For instance, certain categories of summary data may not have any values that are dynamically changeable, and thus do not have associated dynamic threshold values. As mentioned, dynamic threshold values are dynamically changeable values that define the summary data that is to be extracted from the site system.

At step 1618, the site-specific codes and the dynamic threshold values associated therewith are provided. Summary data is received at step 1620 in response to execution of one or more extraction scripts, and may be received in association with a particular site-specific code. The extraction scripts, in one embodiment, are stored and executed on a site system. Once the site-specific codes and dynamic threshold values are received, the site system tunes the extraction scripts so that the extraction scripts specifically identify the site-specific codes and dynamic threshold values and the desired summary data is extracted from the site. At step 1622, the mapping of the site-specific codes and standard codes is utilized to format the summary data for presentation. Once formatted, the summary data may be accessible to various sites that have provided the summary data, and may also be accessible to other third parties (e.g., public health officials). In one embodiment, it may be determined that additional summary data is to be retrieved. The site-specific codes associated with the additional summary data are communicated to the site system.

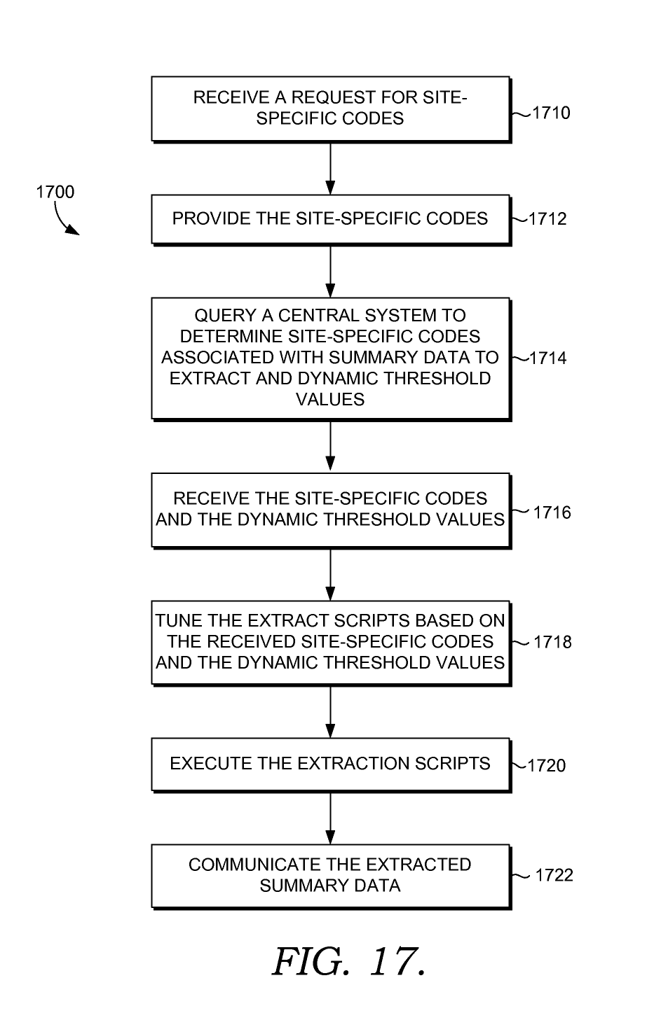

Referring now to FIG. 17, a method 1700 is shown for requesting dynamic threshold values, in accordance with an embodiment of the present invention. At step 1710, a request for site-specific codes is received. Each site-specific codes corresponds to a category of summary data. At step 1712, the site-specific codes are provided to a central system that maps each of the site-specific codes to a standard code. At step 1714, a central system is queried to determine site-specific codes associated with summary data that is to be extracted, in addition to dynamic threshold values. The site-specific codes are identified in a set of extraction scripts that are used to extract summary data associated with the identified site-specific codes. The dynamic threshold values, which are dynamically changeable values that define the summary data that is to be extracted, are determined for at least one of the site-specific codes. In one instance, an upper and lower threshold value comprise the dynamic threshold values. Further, in an embodiment of the present invention, the query for the dynamic threshold values is issued to the central system at periodic intervals of time, such as regular intervals of time or irregular intervals of time. At step 1716, an indication of the site-specific codes and the dynamic threshold values are received. Based on the site-specific codes and the dynamic threshold values, the set of extraction scripts is tuned to identify the site-specific codes and to incorporate the dynamic threshold values into the extraction scripts, shown at step 1718. The set of extraction scripts is executed at step 1720 to extract the summary data. At step 1722, the extracted summary data is communicated.

While numeric thresholds have been discussed herein, the dynamic threshold values may also be values or changes to logic. For instance, a set of codified values may change over time. An exemplary logic of “IF clinical parameter [A, B and C], then respond with action X.” Over time, this logic may need to be updated to reflect changes in research, opinions on which parameters should met, etc. Therefore, a site system may communicate a request or query the central system asking for updated logic prior to the execution of a particular rule. Updated logic, such as a set of codified values, may be determined by the central system. A database may be accessed to retrieve this information. The values, such as updated logic, may then be communicated to the site system from which the request was communicated.

In one instance, the logic returned to the site system may have been changed to “IF clinical parameter [A, B, C and D], then respond with action X” or even “IF clinical parameter [A, B and C], then respond with action Y” or “IF clinical parameter [A, B, or C], then respond with action X.” In this last case, “and” is replaced with “or.” In one embodiment, A, B, C, and D could be various blood test results associated with a particular patient, and X and Y could be actions such as recommending the patient to undergo further testing, intercepting a certain drug order, etc. When the site system receives the updated logic, the site system may tune the rule to include the updated logic. The examples provided above as updates to the logic are provided for exemplary purposes only, and are not intended to limit the scope of the present invention. Although not specifically mentioned here, there are many other variations of changes to logic, numerical values, alphanumerical values, etc., that can be used in association with the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform a method comprising:
determining one or more categories of summary data associated with the summary data that is to be retrieved;
receiving site-specific codes that correspond to the one or more categories of summary data;
mapping the site-specific codes to a set of standard codes;
receiving the summary data from a site system in response to execution of a set of one or more extraction scripts on the site system, wherein the set of one or more extraction scripts identifies the site-specific codes that correspond to the one or more categories of the summary data; and
utilizing the mapping to format the summary data for presentation.

2. The media of claim 1, further comprising:
receiving a request from the site system for the site-specific codes that are to be identified in the set of one or more extraction scripts; and
communicating the site-specific codes that are to be identified in the set of one or more extraction scripts.

3. The media of claim 1, further comprising:
determining that additional summary data is to be retrieved; and
communicating additional site-specific codes associated with the additional summary data to the site system.

4. The media of claim 1, wherein mapping the site-specific codes to the set of standard codes further comprises:
associating each of the site-specific codes with the standard code, wherein both the site-specific code and the associated standard code represent a similar category of the summary data; and
storing the association of the site-specific codes and the standard codes in a database.

5. The media of claim 1, wherein the summary data, once formatted, is accessible to various sites that have provided the summary data and to other third parties.

6. The media of claim 5, wherein a particular site from which the summary data is received is provided access to the summary data received from other sites.

7. The media of claim 1, wherein a site identifier is received with the summary data so that the site system from which the summary data has been communicated can be identified.

8. The media of claim 1, wherein the received summary data is communicated in association with the respective site-specific codes.

9. One or more computer storage media storing computer-useable instructions that, when used by one or more computing devices, cause the one or more computing devices to perform a method comprising:
receiving a request for site-specific codes that correspond to one or more categories of summary data;
providing the site-specific codes, wherein the site-specific codes are provided to a central system that maps the site-specific codes to standard codes;
querying a central system to determine a subset of the site-specific codes to be identified in a set of one or more extraction scripts, wherein when executed, the set of one or more extraction scripts extracts the summary data associated with the identified site-specific codes;
receiving an indication of subset of the site-specific codes to be identified in the set of one or more extraction scripts; and
based on the received site-specific codes, tuning the set of one or more extraction scripts to identify the subset of the site-specific codes;
executing the set of one or more extraction scripts to extract the summary data; and
communicating the extracted summary data.

10. The media of claim 9, further comprising receiving additional site-specific codes associated with additional categories of summary data.

11. The media of claim 10, further comprising incorporating the additional site-specific codes into the set of one or more extraction scripts such that when executed, the set of one or more extraction scripts will extract the summary data associated with the additional categories.

12. The media of claim 9, further comprising encrypting the extracted summary data prior to its communication to a central system.

13. The media of claim 9, wherein the set of one or more extraction scripts is executed by a site system and is stored in a site database.

14. The media of claim 13, wherein the extracted summary data comprises a portion of a total amount of the summary data stored in the site database.

15. The media of claim 9, wherein the summary data is extracted from electronic medical records.

16. The media of claim 9, further comprising receiving the set of one or more extraction scripts.

17. A system for extracting summary data, the system comprising:
a web service that receives requests from site systems and in response to the requests provides the site systems with one or more site-specific codes that correspond to categories of the summary data to be extracted from the site systems,
wherein upon receiving the one or more site-specific codes, the site systems tune a set of one or more extraction scripts prior to its execution so that the extraction scripts identify the one or more site-specific codes that correspond to the categories of the summary data that to be retrieved, and
wherein the web service further maps each of the one or more site-specific codes to a standard code;
an aggregator that receives the summary data extracted from the site systems and that assembles and formats the summary data for presentation; and
a central database that stores the summary data received from the site.

18. The system of claim 17, wherein mapping each of the one or more site-specific codes to the standard code further comprises:
associating each of the one or more site-specific codes with the standard code, wherein both the site-specific code and the associated standard code represent a similar category of the summary data; and
storing the association of the site-specific codes and the standard codes in the central database.

19. The system of claim 17, wherein the categories of summary data correspond to one or more of a healthcare order, a clinical event, or a diagnosis.

20. The system of claim 18, wherein the aggregator, upon receiving the summary data, utilizes the mapping of the site-specific codes and the standard codes to determine the category to which the summary data corresponds.
